(19) United States
(12) Patent Application Publication
(10) Pub. No.: US 2005/0068977 A1
(43) Pub. Date: Mar. 31, 2005

(54) Apparatus and method for servicing both wide area broadcasting and local area broadcasting in a digital multimedia broadcasting system and terminal for receiving the broadcast

(76) Inventors: Kyoung-Weon Na, Seoul (KR); Sang-Hyuk Lee, Gungo-si (KR); Kyung-Ha Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/734,139

(22) Filed: Dec. 15, 2003

(30) Foreign Application Priority Data
Sep. 25, 2003 (KR) 2003-66626

(51) Int. Cl. H04J 3/26

(52) U.S. Cl. 370/432

(57) ABSTRACT

An apparatus and method for servicing both a wide area broadcasting and a local area broadcasting in a digital multimedia broadcasting system. The apparatus includes a means for transmitting program association tables and program map tables in a form of transport stream packets, wherein each of the program association tables includes packet identifications of program map tables corresponding to at least one wide area broadcasting program and at least one local area broadcasting program, and each of the program map tables includes detailed information about corresponding local area broadcastings.

### PRIORITY

This application claims priority to an application entitled “Apparatus and method for servicing both wide area broadcasting and local area broadcasting in digital multimedia broadcasting system and terminal for receiving the broadcastings” filed in the Korean Industrial Property Office on Sep. 25, 2003 and assigned Serial No. 2003-66626, the contents of which are incorporated herein by reference.

### BACKGROUND OF THE INVENTION

1. Field of the Invention

The present invention relates to a digital multimedia broadcasting system, and more particularly to an apparatus and method, which can provide changing various local information in real time to receivers in a predetermined local area, and a receiver for receiving the broadcast by the method.

2. Description of the Related Art

Developments in data compression technology and communication technology for audio and video signals, etc., have provided Digital Multimedia Broadcasting (DMB). The digital multimedia broadcasting includes broadcastings, which are called “Digital Audio Broadcasting (DAB)”, “Digital Radio Broadcasting (DRB)”, “Digital Audio Radio System (DARS)”, etc. In the present specification, “digital multimedia broadcasting” will be used as the general term for such broadcastings. The digital multimedia broadcasting system enables either mobile terminals, stationary terminals, or portable terminals to receive broadcasting information containing various contents such as music, text, dynamic images, etc.

In general, broadcasting information is transmitted to a great number of receivers distributed over a wide area. However, it is sometimes preferred that the digital multimedia broadcasting system transmits local information concerning a specific local area to specific receivers. For example, information about a predetermined local area, such as local news, weather, or transport information, may be useful only for receivers located in the predetermined local area (i.e., users or subscribers carrying the receivers) and may be unnecessary for receivers in other areas. Therefore, a local area information service which can transmit predetermined local area information to receivers located in predetermined area.

In a conventional method of providing local area information, a plurality of dedicated local area broadcasting channels are employed separately from wide area broadcasting channels. The local area information is transmitted through the dedicated local area broadcasting channels. A user can receive desired information through one channel selected from among the dedicated local area broadcasting channels and the wide area broadcasting channels. However, the employment of the dedicated channels for the local area broadcasting results in a waste of bandwidth. In addition, the conventional method may result in confusion when the user selects a broadcasting channel of a local area different from that of another local area for which the user wants to get information. For example, for traffic information, when a user carrying a receiver has erroneously selected a broadcasting channel for a first local area (e.g., Kyeongju, a Korean city) although the user is located in a second local area (e.g., Suwon, another Korean city) different from the first local area, not only the traffic information is unwanted by the user. The user may also feel confused prior to the user understand his or her mistake.

In order to overcome such problems as described above, Korean Patent Publication No. 2000-35152, published on Jun. 26, 2000, which is incorporated herein by reference, discloses a system which can transmit information of multiple local areas with their area identification codes through one or several broadcasting channels. Herein, each of the area identification codes is contained in a header of a data packet for each local area information. In the disclosed system, each receiver monitors received signals, and reproduces information for a local area when a header of a received data packet contains an area identification code of the local area, which has been stored in advance in the receiver.

However, in the conventional system as described above, a receiver cannot receive a wide area broadcasting while receiving a local area broadcasting preventing a user from viewing the wide area broadcasting simultaneously with the local area broadcasting. Further, in the conventional system, the receiver must monitor the headers of the data packets for all the local area broadcastings.

### SUMMARY OF THE INVENTION

Accordingly, the present invention has been made to solve the above-mentioned problems occurring in the prior art, and an object of the present invention is to provide a receiver and a system for digital multimedia broadcasting, which enables a user to receive local information for a predetermined local area while simultaneously viewing a wide area broadcasting.

It is another object of the present invention to provide a method, which can control corresponding information pertaining to local areas to be broadcast to digital multimedia broadcasting receivers with reference to location information of the receivers which changes every moment.

It is another object of the present invention to provide a digital multimedia broadcasting receiver, which can display a local area broadcasting in different modes according to whether a wide area broadcasting is being viewed and the type of wide area broadcasting.

In order to accomplish this object, there is provided an apparatus for servicing both a wide area broadcasting and a local area broadcasting in a digital multimedia broadcasting system. The apparatus comprises a means for transmitting program association tables and program map tables in transport stream packets, wherein each of the program association tables includes packet identifications of program map tables corresponding to at least one wide area broadcasting program and at least one local area broadcasting program, and each of the program map tables includes detailed information about corresponding local area broadcastings.

Another aspect of the present invention provides an apparatus for servicing both a wide area broadcasting and a local area broadcasting in a digital multimedia broadcasting system. The apparatus comprises a means for transmitting program association tables and program map tables in transport stream packets, wherein each of the program association tables includes packet identifications of program map tables corresponding to at least one wide area broadcasting program and at least one local area broadcasting program, and each of the program map tables includes detailed information and location identification codes for specific local area broadcasting programs.

Another aspect of the present invention provides a digital multimedia broadcasting receiver comprises a display unit for receiving and displaying a wide area broadcasting or a local area broadcasting; and a control unit for receiving a local area broadcasting in a local area broadcasting receiving mode, the control unit controlling the display unit to display a local area broadcasting program in a mode according to whether the wide area broadcasting is being received.

A further aspect of the present invention provides a method of receiving a local area broadcasting by a digital multimedia broadcasting receiver. The method comprises the steps of (1) examining whether the digital multimedia broadcasting receiver is in a local area broadcasting receiving mode or not; (2) examining a program association table to determine whether or not there exists a local area broadcasting currently being serviced, when the digital multimedia broadcasting receiver is in the local area broadcasting receiving mode; (3) displaying information of local area broadcastings currently being serviced, when there exists at least one local area broadcasting currently being serviced; and (4) receiving and displaying a specific local area broadcasting when selection of the specific local area broadcasting by a user is detected.

Another aspect of the present invention provides a method of receiving a local area broadcasting by a digital multimedia broadcasting receiver. The method comprises the steps of (1) determining whether the digital multimedia broadcasting receiver is set to come into a local area broadcasting receiving mode or not during reception of a wide area broadcasting; (2) examining a packet corresponding to a program association table from a received transport stream to determine whether or not there exists a local area broadcasting currently being serviced, when setting of the local area broadcasting receiving mode is detected; (3) when there exists a local area broadcasting currently being serviced, acquiring a program map table of the local area broadcasting from the program association table and checking whether a location identification code of the local area broadcasting coincides with a stored location identification code or not; and (4) decoding signals of the local area broadcasting and displaying the local area broadcasting when the location identification code of the local area broadcasting coincides with the stored location identification code.

In accordance with another aspect of the present invention, there is provided a method of receiving and displaying a local area broadcasting by a digital multimedia broadcasting receiver. The method comprising the steps of (1) examining a kind of received local area broadcasting program data; (2) checking whether there exists or not wide area broadcasting program data which are of the same kind as the kind of the local area broadcasting program data; and (3) displaying the local area broadcasting program data when there exists no wide area broadcasting program data of the same kind.

### BRIEF DESCRIPTION OF THE DRAWINGS

The above and other objects, features and advantages of the present invention will be more apparent from the following detailed description taken in conjunction with the accompanying drawings, in which:

FIG. 1A is a block diagram of a first apparatus for constructing a transport data stream containing local area information according to an embodiment of the present invention;

FIG. 1B is a block diagram of a second apparatus for constructing a transport data stream containing local area information according to an embodiment of the present invention;

FIG. 3 is a block diagram of a receiver for a digital multimedia broadcasting according to an embodiment of the present invention;

FIGS. 4A and 4B illustrate a structure of a transport stream according to an embodiment of the present invention;

FIG. 5 is a flowchart illustrating a method of receiving local area broadcasting by a digital multimedia broadcasting receiver according to an embodiment of the present invention;

FIG. 6 is a block diagram illustrating another structure of a transport steam according to another embodiment of the present invention;

FIG. 7 is a flowchart of receiving local area information in a digital multimedia broadcasting receiver according to an embodiment of the present invention; and

FIG. 8 is a flowchart of a process for displaying a local area broadcasting program in a digital multimedia broadcasting receiver according to an embodiment of the present invention.

### DETAILED DESCRIPTION OF THE PREFERRED EMBODIMENT

Several embodiments of the present invention will be described with reference to the accompanying drawings. The same elements will be designated by the same reference numerals. A detailed description of known functions and configurations incorporated herein will be omitted for conciseness. Further, various definitions found in the following description, such as specific values of packet identifications, contents of displayed information, etc., are provided as examples, and it should be apparent to those skilled in the art that the present invention is not limited to the examples shown.

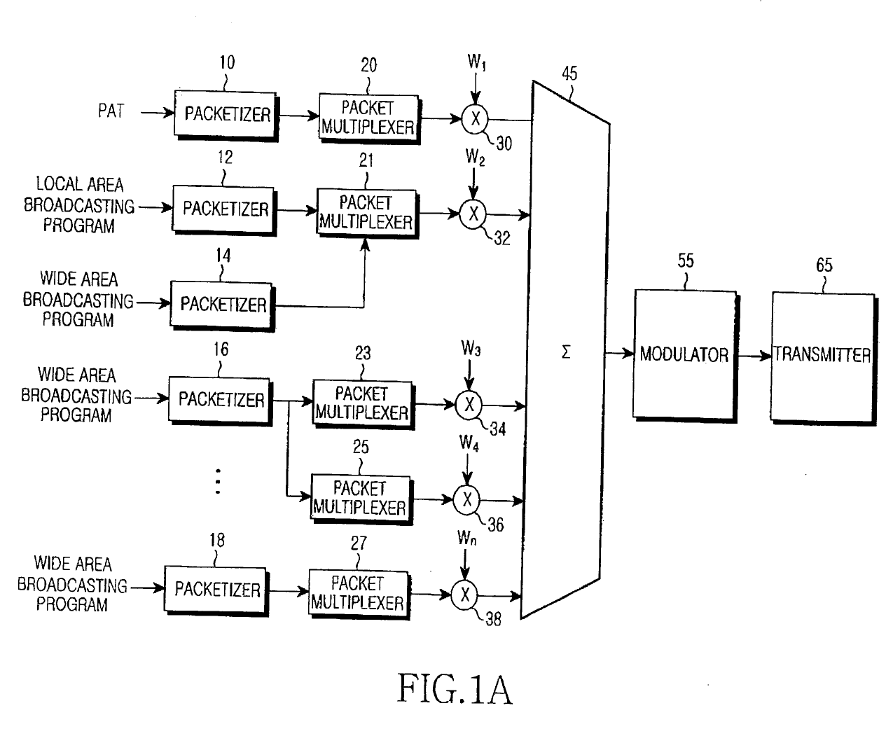

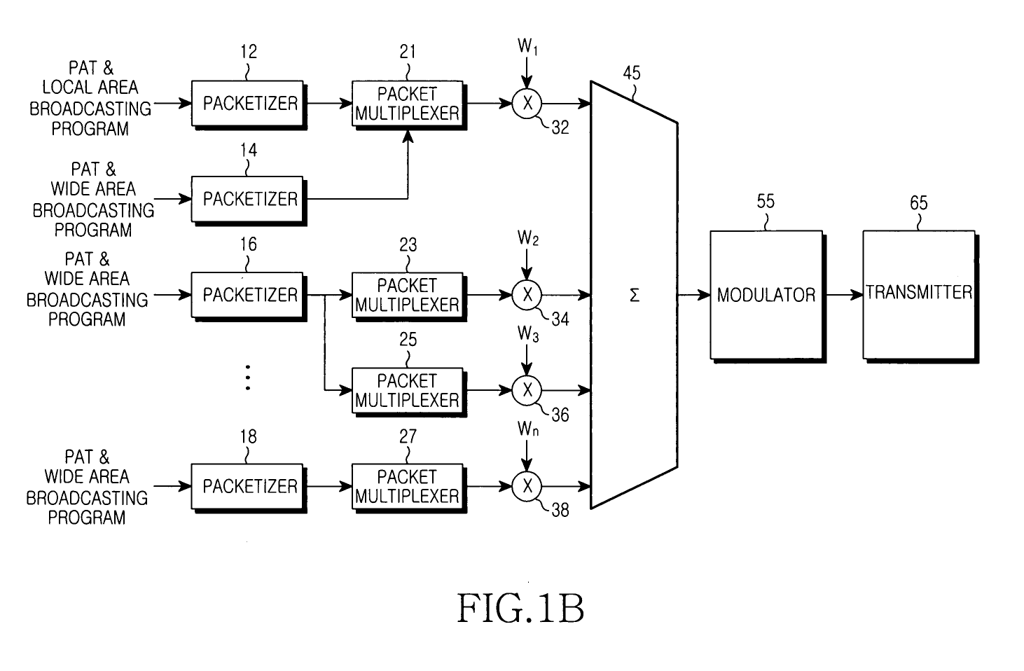

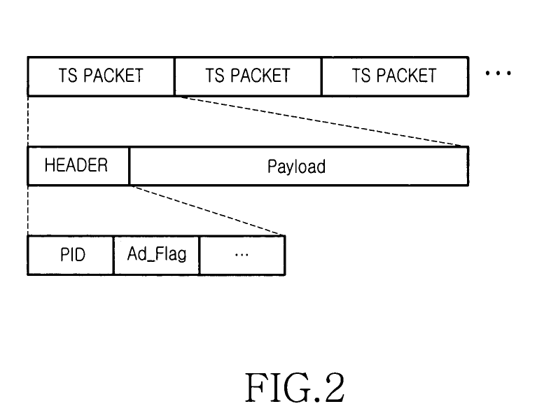

FIG. 1A is a block diagram of a first apparatus for constructing a transport data stream containing local area information according to an embodiment of the present invention.

In the first apparatus, a packetizer 10 divides Program Specific Information (hereinafter, referred to as “PSI”) into Packetized Elementary Streams (hereinafter, each will be referred to as “PES”), each of which has a proper length so that it is called a PES packet. A packet multiplexer 20 multiplexes the PES packets to produce one bit stream, i.e., a Transport Stream (TS) packet. The produced transport stream packet is input to a spreader 30 and spread by a spreading code W₁ in the spreader 30. The spreading code is assigned to each channel and is usually a Walsh code. In the present embodiment, the PSI is transmitted through a common channel which is designated by W₁. Meanwhile, the PSI transmitted through the common channel will be described later in detail.

Each of local area broadcasting programs and wide area broadcasting programs includes at least one of voice data, image data, and text data, each of which is compressed using its own compression algorithm. Packetizers 12, 14, 16, and 18 each divides the compressed voice, image, and text data into PES packets, each having a proper length. Herein, the local area broadcasting program represents information specified for a predetermined local area which may include, e.g., traffic situation, weather situation, unexpected disaster, and local news in the predetermined local area, and service or advertisement specific to the predetermined local area. In contrast, the wide area broadcasting program includes information to be supplied to all receivers in the wide area.

Each of the PES packets has a length up to an upper limit of 65 KB allowing the packets to correspond to various applications. Further, each of the PES packets may have either a fixed length or a variable length, and may be transmitted either at a variable speed or discontinuously.

Packet multiplexers 21, 23, 35, and 27 multiplex the PES packets into one bit stream to produce a transport stream packet. In the present embodiments of the present invention, it will be assumed that a mobile multimedia broadcasting system multiplexes and transmits voice, image, and text data according to a standard of Moving Picture Experts Group 2_Transport Stream (MPEG2_TS). However, it should be noted that the embodiments of the present invention may be employed in other multiplexing methods which can multiplex a plurality of programs into one bit stream.

Programs included in multiple transport stream packets are input to spreaders 32, 34, 36, and 38, respectively. The spreaders 32, 34, 36, and 38 spread the programs using spreading codes W₂, W₃, . . . , Wₙ different from each other. The spreading codes W₂, W₃, . . . , Wₙ are Walsh codes assigned to channels, respectively. In the embodiments of the present invention, it will be assumed that channels are divided by Code Division Multiplexing (CDM). However, it should be noted that the embodiments of the present invention may be employed in other multiplexing methods such as the Orthogonal Frequency Division Multiplexing (OFDM).

A summer 45 sums the transport stream packets, which have been spread by the spreaders, into a code division multiplexed broadcasting signal of 1 series. A modulator 55 modulates the code division multiplexed broadcasting signal by a digital modulation scheme such as Quadrature Phase Shift Keying (QPSK) or Quadrature Amplitude Modulation (QAM). A transmitter 65 converts the frequency of the modulated broadcasting signal into a frequency suitable for radio transmission and amplifies the power of the signal to a level of transmission power, and then transmits it through an antenna (not shown).

Although FIG. 1A shows a plurality of wide area broadcasting programs to be transmitted, the description is given of only one wide area broadcasting program relating to the local area broadcasting program. In other words, the transmission of wide area broadcasting programs through the packetizers 16 and 18 only expresses two cases, including a case in which the wide area broadcasting program is transmitted through two divided channels and another case in which the wide area broadcasting program is transmitted through a single channel, respectively, and is not a main idea of the present invention, and thus will not be described any further below.

FIG. 1B is a block diagram of a second apparatus for constructing a transport data stream including local area information according to an embodiment of the present invention.

The second apparatus has nearly the same elements as those of the first apparatus shown in FIG. 1A, except that the second apparatus does not have a separate common channel for transmitting PSI, and the PSI is transmitted through a broadcasting data channel through which a local area broadcasting program or a wide area broadcasting program is transmitted.

FIG. 2 illustrates a structure of a transport stream of one channel according to an embodiment of the present invention.

The transport stream includes a plurality of transport stream (TS) packets. Each of the transport stream packets is a packet having a fixed length of 188 bytes, which has been determined in consideration of matching to the length of the Asynchronous Transfer Mode (ATM) cell and adaptability in case of Error Correction Coding (ECC) such as Reed-Solomon coding. Each of the transport stream packets includes a packet header having a fixed length of 4 bytes, and an adaptation field and a payload, each having a variable length. The packet header includes information of programs comprising the entire stream, time information of the programs, control information for control of the entire system, etc. Especially, a Packet Identification (PID) is defined in the packet header. The PID represents the broadcasting station in which the data in the corresponding transport stream packet have been generated and the type of program (the type of the transport stream packet, such as voice data or image data). Each of the transport stream packets may include either one of or both of an adaptation field and a payload. Existence or absence of each of them is represented by a flag adaptation_field_control (Ad_Flag) in the packet header. Especially, according to an embodiment of the present invention, the Ad_Flag is set as 1 when a predetermined area of the adaptation filed includes a location identification code.

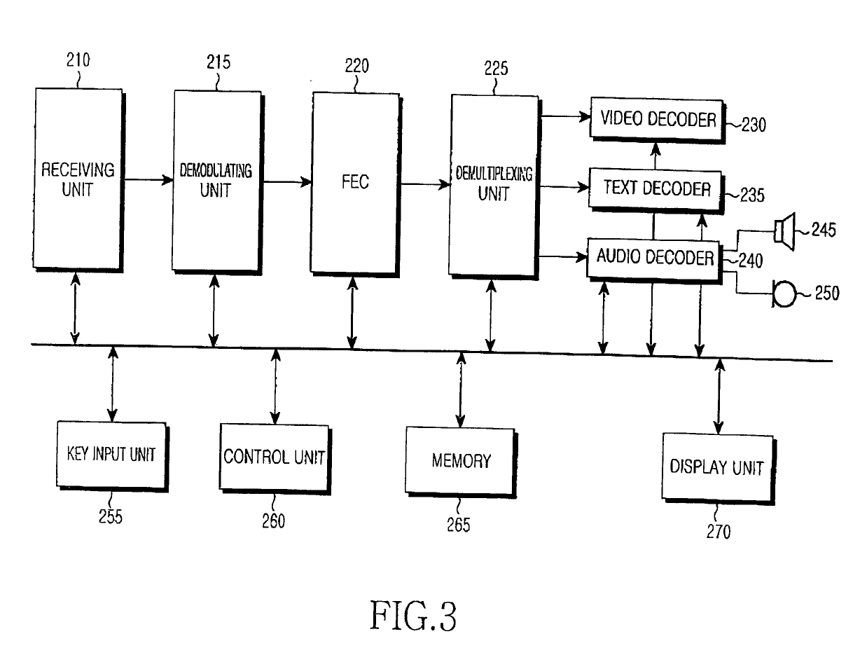

FIG. 3 is a block diagram of a receiver for a digital multimedia broadcasting according to an embodiment of the present invention.

A receiving unit 210 receives digital multimedia broadcasting channel signals, low-noise amplifies the signals, and frequency-converts the signals to signals of intermediate frequency. A demodulating unit 215 demodulates the broadcasting channel signals and spectrum-despreads the signals using spreading codes, each of which corresponds to a channel selected by a user. The user can perform the channel selection by operating a key input unit 255 to input desired channel numbers. Then, the transport packets output from the demodulating unit 215 form a transport stream of the selected channel. According to the embodiment of the present invention, a control unit 260 supplies spreading codes corresponding to wide area broadcasting channels and local area broadcasting channels selected by the user to the demodulating unit 215.

A Forward Error Correction (FEC) unit 220 corrects and decodes errors caused during transmission by noise or interference.

A demultiplexing unit 225 receives PID from the control unit 260, extracts a desired transport stream packet from the decoded transport stream by means of the PID, and separates voice packets, image packets, and text data packets from each other. An audio decoder 240 decodes compressed voice data packets, converts the voice data packets to analog signals by a digital analog converter (D/A converter; not shown), and outputs the analog signals through a speaker 245. A video decoder 230 decodes compressed image data packets, converts the decoded image data packets to signals suitable for a display unit 270 by an image processor (not shown), and outputs the signals through the display unit 270. A text decoder 235 decodes compressed text data packets, and outputs the signals through the display unit 270, together with the image data output from the video decoder 230.

The control unit 260 controls the general operation of the receiver. Further, the control unit 260 controls selection of a local area broadcasting channel according to key input by a user, and determines whether a received local area broadcasting channel coincides with the location identification code stored in a memory 265 or not.

The memory 265 includes read-only memory (ROM) and random-access memory (RAM). The ROM stores control programs for performing various control functions and necessary data for the control. According to the embodiment of the present invention, the ROM may especially store the location identification codes which may be either input by a user or automatically set according to the location of the receiver. Herein, the location identification codes may be postal codes, local codes for telephone numbers, or specific location data such as longitudes and latitudes.

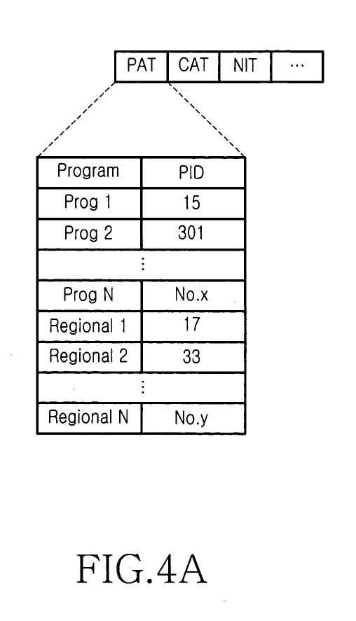

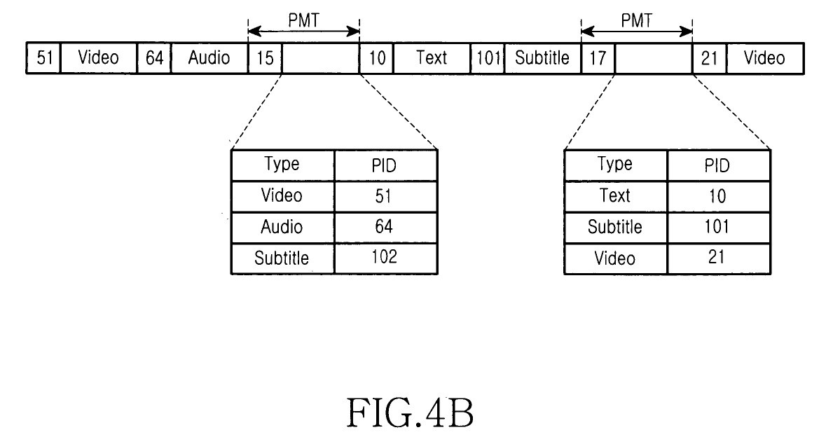

FIGS. 4A and 4B illustrate a structure of a transport stream according to an embodiment of the present invention. Specifically, FIG. 4A illustrates a structure of a PSI transmitted through a common channel, and FIG. 4B illustrates a structure of a transport steam transmitted through a broadcasting data channel, which includes videos, audios, Program Map Tables (hereinafter, each will be referred as “PMT”), and subtitles.

As described above, the transport stream includes a plurality of transport stream packets, each of which consists of a header and a payload. The header includes a PID. In the specification and drawings for the present invention, the header will be identified by only the PID for convenience of description. A Program Association Table (hereinafter, referred to as “PAT”), a Conditional Access Table (hereinafter, referred to as “CAT”), and a Network Information Table (hereinafter, referred to as “NIT”), which are shown in FIG. 4A, together with the PMT shown in FIG. 4B, constitute the PSI. The PSI refers to program information which is defined by the user so as to allow the user to decode the programs in the transport stream. PAT and PMT are information about elements comprising the programs. NIT is information of provisions for the transport network, and CAT is information relating to scrambling where conditional access is necessary. In the embodiment, of the present invention, it will be assumed that the PSI except for the PMT is transmitted through the common channel and the PMT is transmitted through the broadcasting data channel.

Referring to FIG. 4A, in the PAT included in the PSI, the PID is usually defined as ‘0’, which is understood in advance by a receiving-side terminal. As shown, the PAT has PIDs of PMTs corresponding to a plurality of wide area broadcasting programs Prog 1, Prog 2, . . . , and Prog N and local information programs Regional 1, Regional 2, . . . , and Regional N. The local information programs are programs set in advance corresponding to specific local areas. For example, the local information program 1 (Regional 1) may be a program relating to the Seoul area in Republic of Korea, and the local information program 2 (Regional 2) may be a program relating to the Jeju area in Republic of Korea. Meanwhile, the local areas may be either subdivided or incorporated. In the shown PAT, the PMT of the local information program 1 is defined in a packet whose PID is 17, the PMT of the local information program 2 is defined in a packet whose PID is 33, and the PMT of the local information program N is defined in a packet whose PID is No. y.

Referring to FIG. 4B, each PMT includes PIDs of video, audio, and text data packets included in the corresponding program. For example, a PMT of the wide area broadcasting program 1 (Prog 1), whose PID is 15 as shown in FIG. 4A, includes PIDs 51, 64, and 102 of video, audio, and subtitle packets. However, FIG. 4B does not show the subtitle packet having a PID of 102 although it shows the video and audio packets having PIDs of 51 and 64.

Similarly, a PMT of the local area information program 1 (Regional 1), whose PID is 17 as shown in FIG. 4A, includes PIDs 10, 101, and 21 of text, subtitle, and video packets.

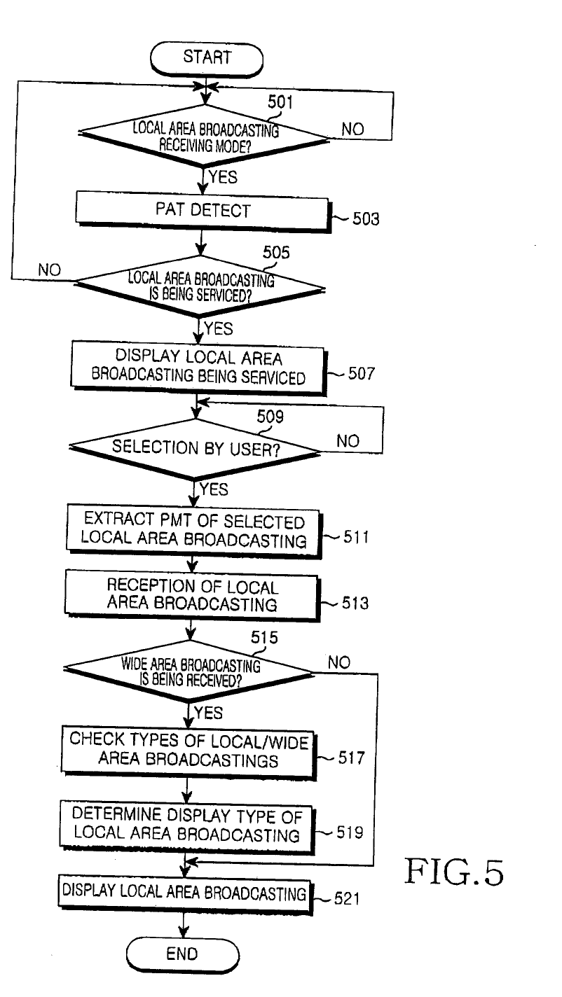

FIG. 5 is a flowchart illustrating a method of receiving local area broadcasting by a digital multimedia broadcasting receiver according to an embodiment of the present invention. Hereinafter, a process in which local area information is transmitted only to predetermined receivers will be described with reference to FIGS. 1A to 4B.

In step 501, the control unit 260 determines whether a digital multimedia broadcasting receiver is set to be in a local area broadcasting receiving mode or not. When a user wants to get local information, the user can preset the receiver to be in a local area broadcasting receiving mode which allows the receiver to receive a local area broadcasting. When it is confirmed that the receiver is in the local area broadcasting receiving mode, the control unit 260 proceeds to step 503.

In step 503, the demultiplexing unit 225 extracts a PAT from common information transmitted through the common channel and provides the PAT to the control unit 260. In step 505, the control unit 260 checks the PAT to determine whether a local area broadcasting program is being serviced or not. That is, the control unit 260 determines whether a PID of PMT for the local area broadcasting program has been set in the PAT or not. Herein, local area broadcasting programs are set in advance according to local areas in the PAT, and the control unit 260 can determine a local area broadcasting program which is being currently serviced from among the local area broadcasting programs in the PAT. When there exists a local area broadcasting program being currently serviced, the process proceeds to step 507. In contrast, when there exists no local area broadcasting program being currently serviced, the process returns to step 501, in which the control unit 260 determines whether reception of a local area broadcasting program is required or not.

In step 507, the control unit 260 controls the display unit 270 to display local area broadcasting programs being currently serviced. Herein, either titles or corresponding local areas of the programs may be displayed on a screen of the display unit 270. Also, instead of all the local area broadcasting programs being currently serviced, only local area broadcasting programs corresponding to a local area in which the digital multimedia broadcasting receiver is currently located or an area set in advance by the user may be displayed by the display unit 270. Here, the location of the digital multimedia broadcasting receiver may be measured using the receiver or set in advance by the user.

In step 509, the control unit 260 detects the key input unit 255 and waits for key input of the user selecting a specific local area broadcasting program. When a local area broadcasting program has been selected, the control unit 260 proceeds to step 511. In step 511, the control unit 260 controls the demodulating unit 215 to select and receive a channel through which the local area broadcasting program selected by the user is broadcast, and the demultiplexing unit 225 receives a transport stream through the FEC unit 220 from the demodulating unit 215, extracts a PMT of the selected local area broadcasting program from a PAT, and provides the PMT to the control unit 260. The control unit 260 extracts PIDs of video, audio, and text data packets comprising the selected local area broadcasting program from the PMT and provides the PIDs to the demultiplexing unit 225. In step 513, the demultiplexing unit 225 separates transport steam packets corresponding to the PIDs received from the control unit 260 and provides the transport stream packets to corresponding decoders.

In step 515, the control unit 260 determines whether the user is currently viewing a wide area broadcasting program or not, in order to determine a display type of the local area broadcasting program. While the user is viewing a wide area broadcasting program, types of data comprising the wide area broadcasting program and the local area broadcasting program are checked in step 517. That is to say, types of data, which are video data, audio data, or text data, included in each program are checked. In step 519, the display type of the local area broadcasting program, that is, a way in which the local area broadcasting program will be displayed, will be determined according to the result of the detection in step 517. In step 521, according to the determined display type, the control unit 260 controls each decoder to decompress the transport stream packet data and output them through the display unit 270 and the speaker 245. Then, the process ends. The sequence of the steps in the process may be changed in such a way that the step of determining whether the user is currently viewing a wide area broadcasting program or not may be may be performed before or after step 501, or at another location in the process.

Meanwhile, from the determination in step 515, when it is determined that the user is not viewing a wide area broadcasting program, the process goes to step 521, in which the local area broadcasting program is displayed as it is. Then, the process ends.

In the embodiment of the present invention, it is assumed that the display type of the local area broadcasting program is determined according to the type of program and whether a wide area broadcasting program is being received or not. When a local area broadcasting program containing only text data is received while a user views a wide area broadcasting program containing image data, the text data may be displayed as a sliding caption on a screen displaying the wide area broadcasting image, improving convenience of the user. Further, when the received local area broadcasting program includes still image data, a Picture In Picture (PIP) screen may used to display the still image data on a window occupying a portion of the screen on which the wide area broadcasting program is displayed. Also, when the display unit 270 of the digital multimedia broadcasting receiver has two separate screens, the still image of the local area broadcasting program and the image of the wide area broadcasting program may be separately displayed on the two screens. Meanwhile, while the user listens to an audio wide area broadcasting program, a local area broadcasting program containing still image data and text data may be displayed on a screen of the display unit 270. Further, when the local area broadcasting program includes still image data and text data, the user can choose display of only the text data without the image data requiring much consumption of power. In this case, according to the kind of the wide area broadcasting program, the text data may be displayed either on the entire screen or as a sliding caption in the screen. The display types of the local area broadcastings will be described later in more detail.

When the local area broadcasting program is used as specific or emergency information and includes only text data which are relatively small-sized data, the received local area broadcasting program may be stored together with time, local area identification, and type of information (e.g., traffic, advertisement, weather, etc.) in a separate memory and may be accessed either according to time units (e.g., daily information) or for each corresponding local area by the user's request.

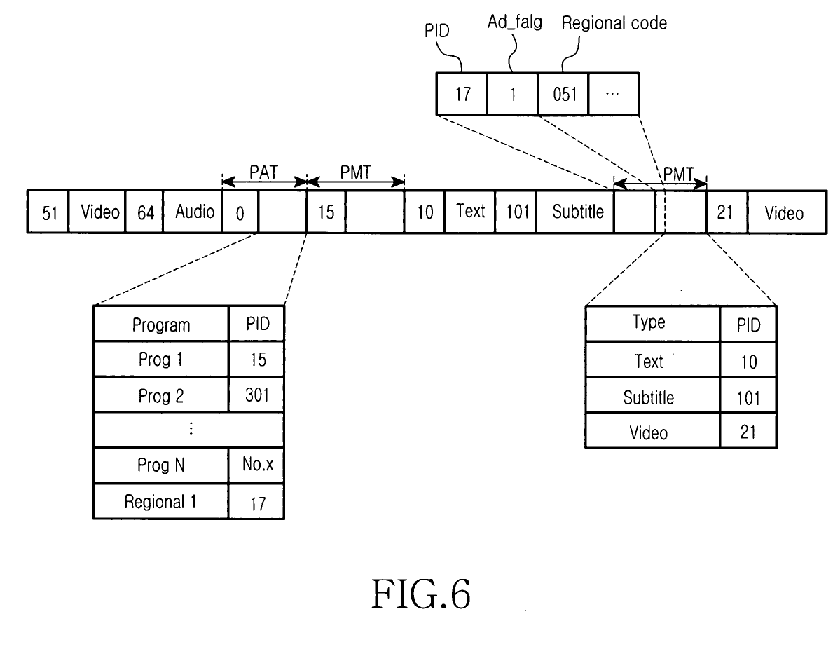

FIG. 6 is a block diagram illustrating another structure of a transport stream according to another embodiment of the present invention. As opposed to FIGS. 4A and 4B, FIG. 6 shows a case in which a PAT together with local area or wide area broadcasting programs is transmitted through a broadcasting channel. The PAT may be transmitted through a common channel as shown in FIGS. 4A and 4B.

Further, the PAT carried by the transport stream shown in FIG. 6 does not includes local area programs set in advance corresponding to specific local areas, that are different from the PAT shown in FIGS. 4A and 4B. The PAT shown in FIG. 6 includes PIDs of PMTs for N wide area broadcasting programs and one local area broadcasting program. However, the one local area broadcasting program is not a program set in advance corresponding to a specific area. Therefore, from an analysis of a PAT received by the receiver, only existence or absence of the local area broadcasting program can be confirmed, but the local area for which the local area broadcasting program cannot be understood. Although this embodiment employs a PAT containing a PID of a PMT for only one local area broadcasting program, it is noted that the PAT may contain PIDs of PMTs for multiple local area broadcasting programs.

Referring to FIG. 6, a transport stream packet, which is a PMT of a local area broadcasting program and has a PID of 17, has a header in which Ad_Flag is set as 1 and an adaptation field exists. A location identification code of the local area broadcasting program is contained in a predetermined area of the adaptation field. Herein, it is assumed that the predetermined area is a private field. The location identification code may be a postal code, a local code for telephone numbers (e.g., ‘051’ may indicate Pusan, a city of Republic of Korea), or specific location data such as longitudes and latitudes.

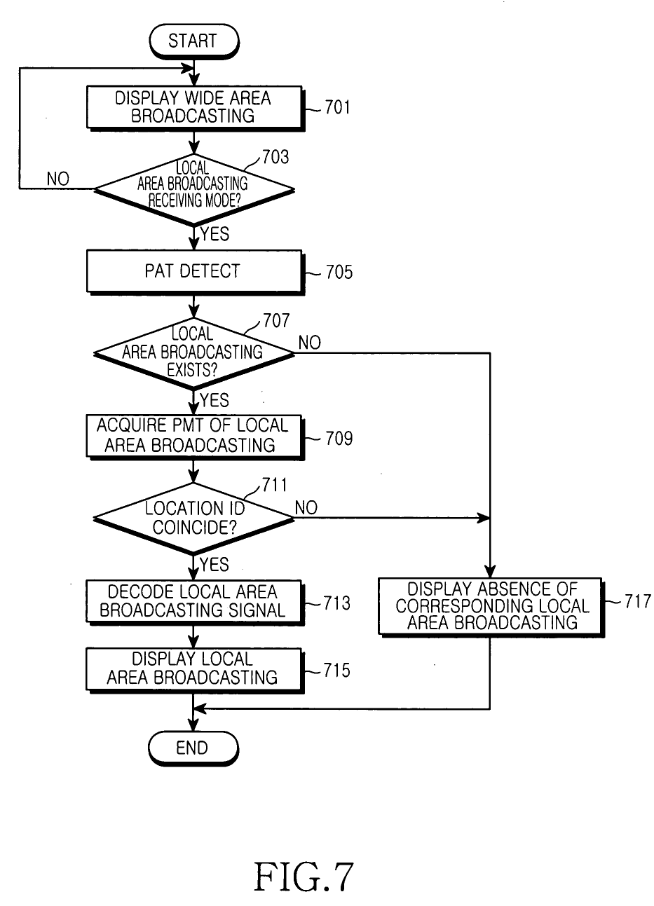

FIG. 7 is a flowchart of receiving local area information in a digital multimedia broadcasting receiver according to an embodiment of the present invention. Hereinafter, a method of transmitting local area information only to predetermined receivers with reference to FIGS. 6 and 7.

In the this embodiment of the present invention, a process performed in order to receive a local area broadcasting while a wide area broadcasting will be described. In step 701, in the digital multimedia broadcasting receiver, the receiving unit 210 and the demodulating unit 215 receive a signal of a wide area broadcasting channel required by a user, and the FEC unit 220 corrects transport error and outputs a transport stream. The demultiplexing unit 225 extracts a PMT of a program which a user wants to view, using a PAT, and provides the extracted PMT to the control unit 260. From the PMT, the control unit 260 obtains PIDs of video, audio, and text data of the program required to be viewed, and provides the PIDs to the demultiplexing unit 225. The demultiplexing unit 225 separates transport stream packets corresponding to the PIDs provided by the control unit 260 and supplies the transport stream packets to corresponding decoders. Each of the decoders decompresses the supplied data and outputs the decompressed data through the display unit 270 or the speaker 245. Then, the user can view the wide area broadcasting through the receiver.

In step 703, the control unit 260 determines whether a digital multimedia broadcasting receiver is set to be in a local area broadcasting receiving mode or not. When a user wants to get local information, the user can preset the receiver to be in a local area broadcasting receiving mode which allows the receiver to receive a local area broadcasting. When it is confirmed that the receiver is in the local area broadcasting receiving mode, the process proceeds to step 705.

In step 705, the control unit 260 extracts a PAT from transport stream packets transmitted through the broadcasting data channel or common channel and proceeds to step 707. In step 707, the control unit 260 checks the PAT to determine whether there exists or not a local area broadcasting program being currently serviced. That is, the control unit 260 checks whether a PID of a PMT for the local area broadcasting program has been set in the PAT or not. In this case, the control unit 260 can confirm only the existence of the local area broadcasting program from the PAT, and the local area for which the local area broadcasting program is serviced can be understood only through reference to a corresponding PMT transport stream packet. Although a description of this embodiment will be given for a case in which only one local area broadcasting program is being serviced, it is noted that the embodiment of the present invention can also be applied even when multiple local area broadcasting programs are being serviced. In the latter case, PIDs of PMTs for local area broadcasting programs must be set in advance in the PAT. When there exists a local area broadcasting program being currently serviced, the process goes to step 709. In contrast, when there exists no local area broadcasting program being currently serviced, the process goes to step 717, in which the control unit 260 controls the display unit 270 to display that no local area broadcasting program is being serviced. Step 717 may be omitted from the process,.

In step 709, the demultiplexing unit 225 acquires the PMT of the local area broadcasting program from the PAT and supplies the PMT to the control unit 260, and goes to step 711. In step 711, the control unit 260 checks an Ad_Flag of the PMT. When the Ad_Flag has been set as 1, the control unit 260 checks the adaptation field and extracts a location identification code from the adaptation field. Then, the extracted location identification code is compared with the location identification code stored in the memory 265. When the extracted location identification code coincides with the location identification code stored in the memory 265, the process goes to step 713. In contrast, when they do not coincide with each other, the process goes to step 717.

In step 713, the control unit 260 extracts PIDs of transport stream packets for the local area broadcasting program from the PMT and supplies the extracted PIDs to the demultiplexing unit 225. The demultiplexing unit 225 separates the transport stream packets corresponding to the supplied PIDs and provides the transport stream packets to corresponding decoders. Each decoder decompresses the transport stream packet provided to the decoder. In step 715, the decompressed data are output through the display unit 270 or the speaker 245. Then, the process is ended. As described above with reference to FIG. 5, the local area broadcasting program can be output through the display unit 270 or the speaker 245 in various ways according to the kinds of the local area broadcasting program and the wide area broadcasting program being currently viewed.

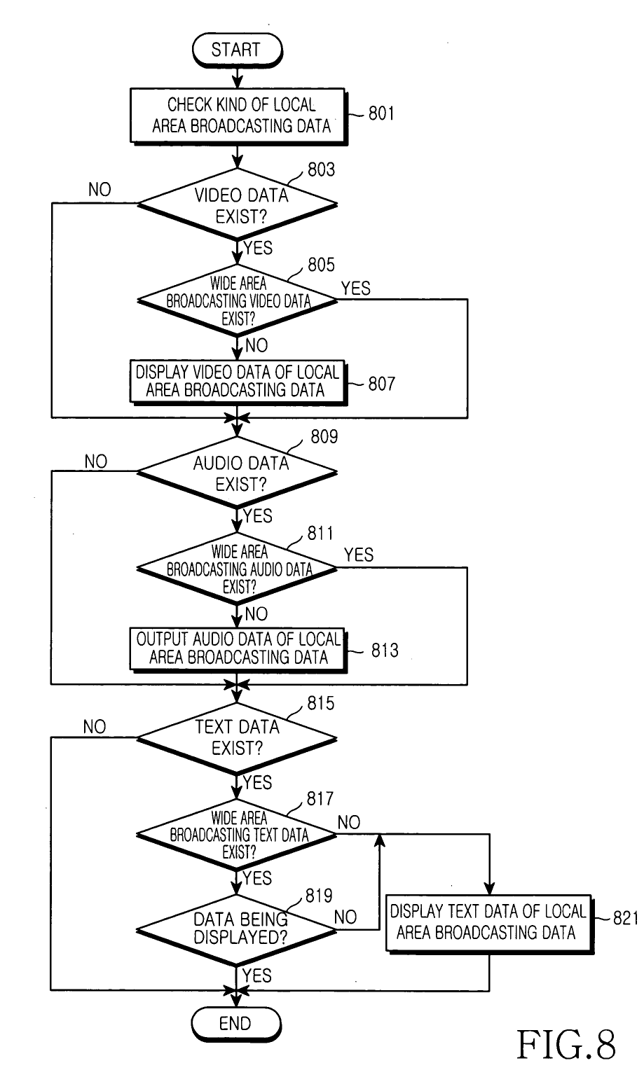

FIG. 8 is a flowchart of a process for displaying a local area broadcasting program in a digital multimedia broadcasting receiver according to an embodiment of the present invention. As described above, the local area broadcasting program includes at least one type of data, from among video data, audio data, and text data. Specifically, the local area broadcasting program shown in FIG. 8 includes at least text data, from among video data, audio data, and text data. However, the local area broadcasting program may include at least video data or audio data.

In step 801, the control unit 260 determines types of data contained in the local area broadcasting program from the PMT of the local area broadcasting program. In step 803, from the result of the detection, the control unit 260 determines whether the local area broadcasting program includes video data or not. When the local area broadcasting program includes video data, the process goes to step 805. When the local area broadcasting program does not include video data, the process goes to step 809. In step 805, the control unit 260 checks whether the wide area broadcasting program includes video data or not. When the wide area broadcasting program includes video data, the process goes to step 809. When the wide area broadcasting program does not contain video data, the process goes to step 807. In step 807, the control unit 260 controls the demultiplexing unit 225 and the video decoder 230 to display the video data of the local area broadcasting program through the display unit 270.

In step 809, the control unit 260 determines whether the local area broadcasting program includes audio data or not from the result of the detection in step 801. When the local area broadcasting program includes audio data, the process goes to step 811, in which the control unit 260 checks whether the wide area broadcasting program includes audio data or not. When the wide area broadcasting program does not contain audio data, the process goes to step 813, in which the audio data of the local area broadcasting program is output. When the local area broadcasting program does not contain audio data in step 809, or when the wide area broadcasting program includes audio data in step 811, the process goes to step 815.

In step 815, the control unit 260 determines whether the local area broadcasting program includes text data or not from the result of the detection in step 801. When the local area broadcasting program includes text data, the process goes to step 817. When the local area broadcasting program does not contain text data, the process ends. As described above, the control unit 260 performs step 817 in this embodiment, since the local area broadcasting program includes at least one text data. In step 817, the control unit 260 determines whether the wide area broadcasting program includes text data or not. When the wide area broadcasting program does not contain text data, the process goes to step 821, in which the text data of the local area broadcasting program are displayed, and the process ends. In contrast, when the wide area broadcasting program includes text data, the process goes to step 819, in which whether video data or audio data of the local area broadcasting program are being output through the display unit 270 or the speaker 245 or not is determined, so as to enable at least the text data of the local area broadcasting program to be displayed even when the text data of the wide area broadcasting program is being displayed on the screen in the case in which no video or voice data is included in the local area broadcasting program or video or voice data of the local area broadcasting program are not output in order to output video or voice data of the wide area broadcasting program.

From the determination in step 819, when it is concluded that data of the local area broadcasting program is not being displayed, the process goes to step 821, in which the text data of the local area broadcasting program are displayed through the display unit 270. In this case, the text data of the wide area broadcasting program either are not displayed or are displayed together with the text data of the local area broadcasting program. However, when the video or audio data of the local area broadcasting program are being currently displayed, the process is ended without displaying the text data of the local area broadcasting program.

As described above, the embodiments of the present invention enables information specified for a predetermined local area to be serviced only to DMB subscribers located in the predetermined local area. Therefore, the embodiments of the present invention can optimize the content of the service for each individual, thereby improving efficiency in use of DMB terminals. Further, the embodiments of the present invention enables users to obtain correct and more useful information. According to the embodiments of the present invention, even stationary DTV can receive data broadcasting specified for a local area in which the stationary DTV is located, and a broadcasting station can provide a specified broadcasting through one data channel that is different from the existing analog broadcasting which can transmit information specified for a predetermined local area by transmitting a separate electric wave only to a repeater for the predetermined local area. Therefore, the embodiments of the present invention can improve efficiency in use of the broadcasting channels, and transmission and relay of broadcastings. Moreover, the embodiments of the present invention is expected to produce an enormous value added. For example, a new advertisement market can be exploited, or unique local culture can be created.

While the invention has been shown and described with reference to certain embodiments thereof, it will be understood by those skilled in the art that various changes in form and details may be made therein without departing from the spirit and scope of the invention as defined by the appended claims. The embodiments of the present invention may be employed not only in mobile terminals but also in stationary or mobile digital televisions which can provide data services.

1. An apparatus for servicing both a wide area broadcasting and a local area broadcasting in a digital multimedia broadcasting system, the apparatus comprising:
means for transmitting program association tables and program map tables in a form of transport stream packets, wherein
each of the program association tables includes packet identifications of program map tables corresponding to at least one wide area broadcasting program and at least one local area broadcasting program, and
each of the program map tables includes detailed information about corresponding local area broadcastings.

2. The apparatus as claimed in claim 1, wherein each of the transport stream packets includes a packet header, and a payload, the packet header including a packet identification which indicates a broadcasting station and types of programs, each of the types of programs indicating at least one of video, audio, and text data.

3. The apparatus as claimed in claim 2, wherein each of the transport stream packets includes at least one of an adaptation field and the payload, existence or absence of which is represented by a flag included in the packet header.

4. The apparatus as claimed in claim 1, wherein the local area broadcasting program is set in advance to correspond to a specific local area.

5. The apparatus as claimed in claim 1, wherein each of the program association tables is transmitted through a common channel and each of the program map tables is transmitted through a broadcasting data channel.

6. The apparatus as claimed in claim 1, wherein each of the program association tables and the program map tables are transmitted through a broadcasting data channel.

7. An apparatus for servicing both a wide area broadcasting and a local area broadcasting in a digital multimedia broadcasting system, the apparatus comprising:
means for transmitting program association tables and program map tables in a form of transport stream packets, wherein
each of the program association tables includes packet identifications of program map tables corresponding to at least one wide area broadcasting program and at least one local area broadcasting program, and
each of the program map tables includes detailed information and location identification codes for specific local area broadcasting programs.

8. The apparatus as claimed in claim 7, wherein each of the transport stream packets includes a packet header, and an adaptation field or a payload, each of the adaptation field and the payload having a variable length.

9. The apparatus as claimed in claim 8, wherein the packet header includes a packet identification which indicates a broadcasting station and types of programs, each of the types of programs indicating at least one of video, audio, and text data.

10. The apparatus as claimed in claim 8, wherein a location identification code of a local area broadcasting program is recorded in an adaptation field of each of the program map tables.

11. The apparatus as claimed in claim 8, wherein a flag included in the packet header represents an existence or absence of the adaptation field or the payload.

12. The apparatus as claimed in claim 7, wherein each of the program association tables is transmitted through a common channel and each of the program map tables is transmitted through a broadcasting data channel.

13. The apparatus as claimed in claim 7, wherein each of the program association tables and the program map tables are transmitted through a broadcasting data channel.

14. A digital multimedia broadcasting receiver comprising:
a display unit for receiving and displaying a wide area broadcasting or a local area broadcasting; and
a control unit for receiving a local area broadcasting in a local area broadcasting receiving mode, the control unit controlling the display unit to display a local area broadcasting program in a correct mode according to whether the wide area broadcasting is being received or not.

15. The digital multimedia broadcasting receiver as claimed in claim 14, wherein the control unit performs operations comprising:
determining whether the digital multimedia broadcasting receiver is in the local area broadcasting receiving mode or not;
examining a program association table, determining whether there exists or not a local area broadcasting currently being serviced, and controlling the display unit to display information of local area broadcastings currently being serviced, when the digital multimedia broadcasting receiver is in the local area broadcasting receiving mode; and
enabling a specific local area broadcasting to be received when a selection of the specific local area broadcasting by a user is detected.

16. The digital multimedia broadcasting receiver as claimed in claim 15, wherein
the program association table includes packet identifications of program map tables corresponding to at least one wide area broadcasting program and at least one local area broadcasting program, and
each of the program map tables includes detailed information about the local area broadcastings including the specific local area broadcasting.

17. The digital multimedia broadcasting receiver as claimed in claim 16, wherein:
the control unit detects packet identification of a program map table for a program which the user requires to view from the program association table and packet identifications of video, audio, or text data from the detected program map table; and
the digital multimedia broadcasting receiver further comprises a demultiplexing unit for extracting the program map table and the video, audio, or text data and transmitting them to the control unit.

18. The digital multimedia broadcasting receiver as claimed in claim 14, wherein the control unit performs operations comprising:
examining a kind of local area broadcasting program data in order to determine a display type of the local area broadcasting program; and
displaying the local area broadcasting program data when the local area broadcasting program data are data of a first kind and no wide area broadcasting program data of the first kind are received or when the local area broadcasting program data are data of the first kind and local area broadcasting program data of another kind are not being displayed while wide area broadcasting program data of the first kind are being received.

19. The digital multimedia broadcasting receiver as claimed in claim 18, wherein the first kind is text and said another kind is video or audio.

20. A digital multimedia broadcasting receiver for receiving a wide area broadcasting or a local area broadcasting, the digital multimedia broadcasting receiver comprising:
a display unit for displaying a wide area broadcasting or a local area broadcasting;
a memory for storing a location identification code; and
a control unit for determining whether the digital multimedia broadcasting receiver is in the local area broadcasting receiving mode or not, detecting detailed information and a location identification code of the local area broadcasting from program specific information when the digital multimedia broadcasting receiver is in the local area broadcasting receiving mode, comparing the detected location identification code with the location identification code stored in the memory, and controlling the display unit to receive and display the local area broadcasting when the detected location identification code coincides with the location identification code stored in the memory.

21. The digital multimedia broadcasting receiver as claimed in claim 20, wherein the location identification code stored in the memory can be input by a user or automatically set according to a location of the digital multimedia broadcasting receiver.

22. The digital multimedia broadcasting receiver as claimed in claim 20, wherein
the program specific information includes a program association table and a program map table, and
the program association table includes packet identifications of program map tables corresponding to at least one wide area broadcasting program and at least one local area broadcasting program.

23. The digital multimedia broadcasting receiver as claimed in claim 22, further comprising:
a demultiplexing unit for extracting a program map table of a program which a user requires to view from the program association table and transmits the program map table to the control unit, wherein
the control unit detects packet identifications of video, audio, or text data of the program which the user requires to view from the detected program map table and transmits the detected packet identifications to the demultiplexing unit.

24. A method of receiving a local area broadcasting by a digital multimedia broadcasting receiver, the method comprising the steps of:
(1) examining whether the digital multimedia broadcasting receiver is in a local area broadcasting receiving mode or not;
(2) examining a program association table to determine whether or not there exists a local area broadcasting currently being serviced, when the digital multimedia broadcasting receiver is in the local area broadcasting receiving mode;
(3) displaying information of local area broadcastings currently being serviced, when there exists at least one local area broadcasting currently being serviced; and
(4) receiving and displaying a specific local area broadcasting when selection of the specific local area broadcasting by a user is detected.

25. The method as claimed in claim 24, further comprising:
displaying the specific local area broadcasting as it is when a wide area broadcasting is not being viewed, after reception of the specific local area broadcasting.

26. The method as claimed in claim 24, further comprising:
when a wide area broadcasting is being viewed, determining kinds of the specific local area broadcasting and the wide area broadcasting and determining a display type for the specific local area broadcasting before displaying the specific local area broadcasting.

27. The method as claimed in claim 24, wherein, in step (3), the information of local area broadcastings currently being serviced comprises titles of local area broadcasting programs.

28. The method as claimed in claim 24, wherein, in step (3), the information of local area broadcastings currently being serviced comprises names of corresponding local areas.

29. The method as claimed in claim 24, wherein the local area broadcastings are set in advance to correspond to predetermined local areas, respectively.

30. The method as claimed in claim 29, further comprising the steps of:
comparing a location corresponding to a local area broadcasting being currently serviced with a location set in the digital multimedia broadcasting receiver; and
displaying information of the local area broadcasting when the location corresponding to the local area broadcasting coincides with the location set in the digital multimedia broadcasting receiver.

31. A method of receiving a local area broadcasting by a digital multimedia broadcasting receiver, the method comprising the steps of:
(1) examining whether the digital multimedia broadcasting receiver is set to come into a local area broadcasting receiving mode or not during reception of a wide area broadcasting;
(2) examining a packet corresponding to a program association table from a received transport stream to determine whether or not there exists a local area broadcasting currently being serviced, when setting of the local area broadcasting receiving mode is detected;
(3) when there exists a local area broadcasting currently being serviced, acquiring a program map table of the local area broadcasting from the program association table and checking whether a location identification code of the local area broadcasting coincides with a stored location identification code or not; and
(4) decoding signals of the local area broadcasting and displaying the local area broadcasting when the location identification code of the local area broadcasting coincides with the stored location identification code.

32. The method as claimed in claim 31, further comprising:
displaying absence of a corresponding local area broadcasting when the location identification code of the local area broadcasting does not coincide with the stored location identification code.

33. The method as claimed in claim 31, wherein the location identification code is recorded on an adaptation field of the packet, which has a variable length.

34. The method as claimed in claim 32, wherein the location identification code is recorded on an adaptation field of the packet, which has a variable length.

35. A method of receiving and displaying a local area broadcasting by a digital multimedia broadcasting receiver, the method comprising the steps of:
(1) examining a kind of received local area broadcasting program data;
(2) checking whether there exists or not wide area broadcasting program data which are of the same kind as the kind of the local area broadcasting program data; and
(3) displaying the local area broadcasting program data when there exists no wide area broadcasting program data of the same kind.

36. The method as claimed in claim 35, wherein the kind of the local area broadcasting program data is video.

37. The method as claimed in claim 35, wherein the kind of the local area broadcasting program data is audio.

38. The method as claimed in claim 35, wherein the kind of the local area broadcasting program data is text.

39. The method as claimed in claim 35, further comprising:
when the kind of the local area broadcasting program data is a first kind and there exists a first kind of wide area broadcasting program data, checking whether the first kind of local area broadcasting program data is being currently displayed or not, so that the local area broadcasting program data is not displayed when the first kind of wide area broadcasting program data is being currently displayed.

40. The method as claimed in claim 35, wherein the local area broadcasting program data are displayed when the local area broadcasting program data are data of a first kind and no wide area broadcasting program data of the first kind exist or when the first kind of the local area broadcasting program data are not being currently displayed while wide area broadcasting program data of the first kind exist.

41. The method as claimed in claim 39, wherein the first kind is text.

42. The method as claimed in claim 40, wherein the first kind is text.

43. A method of receiving a local area broadcasting by a digital multimedia broadcasting receiver, the method comprising the steps of:
(1) examining whether the digital multimedia broadcasting receiver is in a local area broadcasting receiving mode or not;
(2) examining program specific information to determine whether or not there exists a local area broadcasting currently being serviced, when the digital multimedia broadcasting receiver is in the local area broadcasting receiving mode;
(3) displaying information of local area broadcastings currently being serviced, when there exists at least one local area broadcasting currently being serviced; and
(4) receiving and displaying a specific local area broadcasting when selection of the specific local area broadcasting by a user is detected.

44. The method as claimed in claim 43, wherein the program construction information is included in a program association table.

45. The method as claimed in claim 44, wherein the local area broadcasting program is set in advance to correspond to a specific local area.

46. The method as claimed in claim 45, further comprising the steps of:
comparing a location corresponding to a local area broadcasting being currently serviced with a location set in the digital multimedia broadcasting receiver; and
displaying information of the local area broadcasting when the location corresponding to the local area broadcasting coincides with the location set in the digital multimedia broadcasting receiver.

47. The method as claimed in claim 43, wherein the program construction information is included in a program association table and a program map table

48. The method as claimed in claim 43, further comprising:
when there exists a local area broadcasting currently being serviced, acquiring a program map table of the local area broadcasting from the program association table and checking whether a location identification code of the local area broadcasting coincides with a stored location identification code or not
